(19) United States
(12) Patent Application Publication
(10) Pub. No.: US 2002/0092709 A1
(43) Pub. Date: Jul. 18, 2002

(54) Arrangement at trucks

(76) Inventor: Gerhard Kronewitter, (US)

Correspondence Address: Norman P. Soloway, HAYES, SOLOWAY, HENNESSEY, GROSSMAN & HAGE, P.C., 175 Canal Street, Manchester, NH, 03101, US

(21) Appl. No.: 09/951,192

(22) Filed: Sep. 10, 2001

(30) Foreign Application Priority Data
Sep. 11, 2000 (SE) 0003229-2

(51) Int. Cl. B60T 1/00

(52) U.S. Cl. 188/21; 188/19

(57) ABSTRACT

Arrangement for brake actuation of a hand track operated by a tiller 4 provided with a handle (6) in which a first lever (12) is pivotally journalled. This fist lever is via a wire (16) or the like connected to a brake means, and movement of the first lever (12) influence the brake means between the braking and releasing positions, said first lever (12) being biased towards the brake releasing position. A second lever (18) is also pivotally journalled in the handle (6). The first and second levers (12, 18) include respective mechanical lock parts (22, 24) arranged to cooperate with each other so that the first lever (12) is locked when the first and second levers (12, 18) are in the braking position.

The invention is concerned with an arrangement at he brake of a hand truck or the like including a tiller with a handle and first lever pivotally journalled on a first axle in the handle, said lever being via a wire or the like connected to a brake means. Movement of the first lever transfer the brake means between a braking and a released position, the first lever is by a spring means biased towards a release position.

### PRIOR ART

Hand trucks intended for transportation of for instance load pallets are today common on the market. In some cases they are provided with a brake. These brakes normally function somewhat like a bicycle brake, that is a lever (brake lever) is via a wire or the like connected to a pair of brake shoes that on activation are pressed against a wheel. Normally the brake shoes are spring biased towards a release position.

This solution means that when the brake lever is released the brake is released by the spring pretension and there is thus no parking brake function. In order to achieve a parking brake there are solutions where a pin or the like is journalled in the brake lever. The pin can be turned into one or several recesses arranged in a protrusion on the lever thereby preventing the brake lever from returning to the release position. When it is desired to release the brake the pin is pushed aside with a finger and the brake lever resume its release position.

These parking brake solutions may be somewhat difficult to handle, in particular with gloves. Furthermore they give the hand tuck a comparatively unsophisticated appearance.

### OBJECT OF THE INVENTION

The object of the invention is to achieve a brake device for hand truck or the like with a parking brake function that result in a simple handling and at the same time an aesthetically appealing look without being technically too complicated.

### BRIEF DESCRIPTION OF THE INVENTION

The objects of the invention are achieved with an arrangement where a second lever is pivotally journalled in the handle on a second axle essentially parallel to the first axle. The second lever is moveable between the braking the release positions and the first and second levers include respective mechanical locking parts arranged to cooperate with each other so that the locking parts are free from each other in the release position of the second lever while the locking parts cooperates, when the first and second levers, are in the braking position, in such a way that the spring force of the spring means is overcome and the first lever is locked in its braking position.

Since the brake lever is completed with a second lever for the handbrake function with cooperating locking parts the brake lever can be actuated in the normal way while it is locked in a braking position by the activation of the hand brake lever. The parking brake is then easily released by simply returning the hand brake lever to the release position.

Claim 2 defines a geometrically advantageous solution enabling an arrangement requiring a minimum of space with optimal movement paths of the levers.

Claims 3 and 4 define advantageous embodiments that provide good function with simple shapes for the levers, while claim 5 provides a solution where the cable elegantly can be protected.

The arrangement according to claim 6 enables the use of a third lever for the release of the parking brake, while the claims 7-9 defines suitable arrangements where an already existing lever is arranged and used in an advantageous way.

Further features and advantages of the invention are apparent from the following description of a preferred embodiment with a reference to the enclosed drawings.

### FIGURES

FIG. 1 shows a handle for a hand truck with a brake arrangement in accordance with the invention in rest position and FIG. 2 shows a hand tuck handle with the brake arrangement activated.

### DESCRIPTION OF AN EMBODIMENT

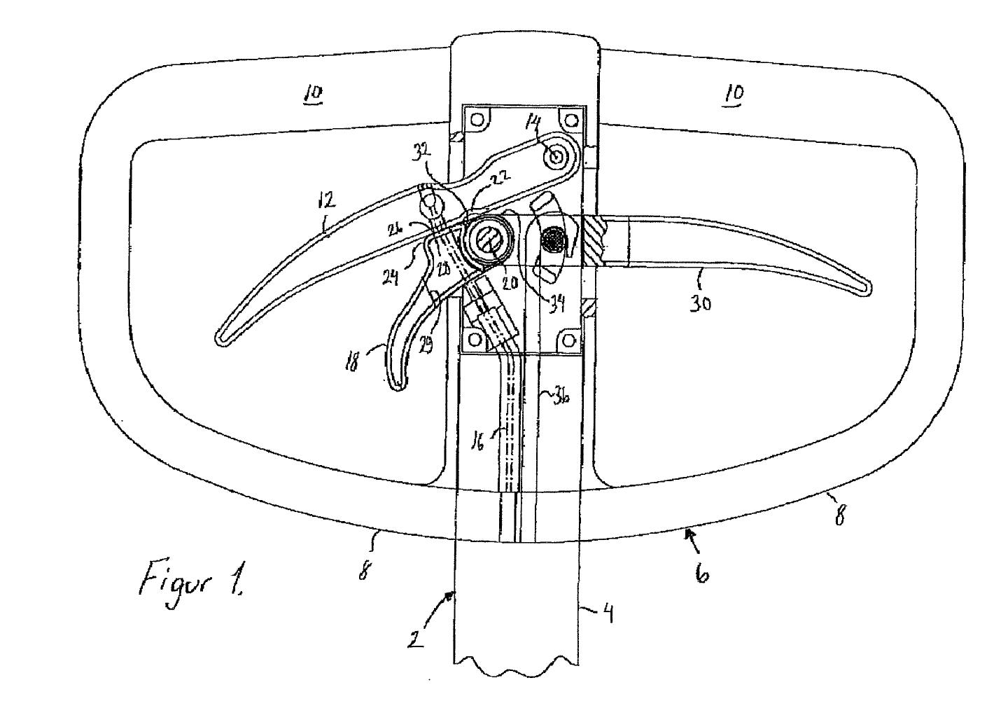

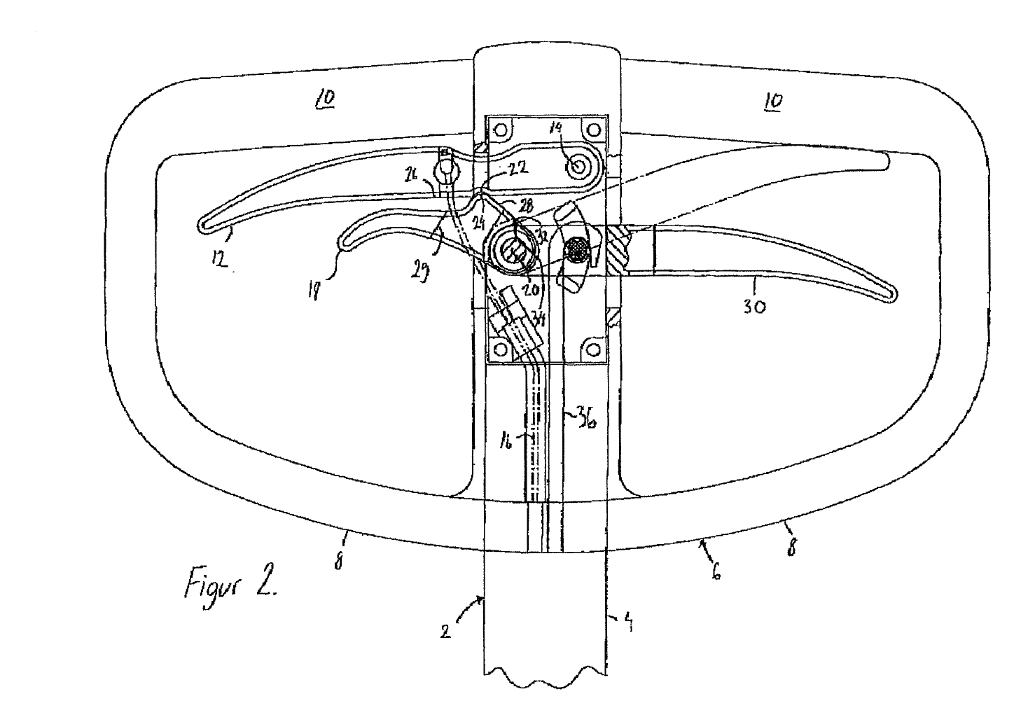

FIG. 1 hows a tiller head 2 of a hand truck including a tiller 4 and a handle 6. With handle is here not only meant the gripping areas themselves but the entire upper part of the tiller. The handle 5 thus includes supports 8 and grips 10 at the end of the tiller 2. In the handle 5 a brake actuator in the shape of a first lever 12 is arranged. The leer 12 is pivotally journalled on a first axle 14. A cable 16 or he like is fastened to the lever 12 for the influencing of not shown brake means in a manner known per se. Preferably the cable 16 is connected to a pair of brake shows that on activation are pressed against a wheel. The brake shoes are spring biased to wards a release position giving the lever 12 the position shown in FIG. 1.

The above described embodiment is essentially known and used on hand trucks. The solution according to the invention further includes an additional second lever 18 pivotally journalled in the handle 6 on a second axle 20 that is essentially parallel to the first axle 14. The cable 16 runs through a passage 29 in the second lever 28. The second lever 18 is used at parking brake locking in a way that is described in detail below.

In the handle 6 a third lever 30 is further pivotally journalled on a third axle that in the shown embodiment coincide with the second axle 20. It is possible with an embodiment with two separate axles, but this will be difficult to achieve with regard to the available space and at the same time the number of parts increase. The third lever 30 acts on a pull rod 36 that in turn acts on a lowering valve (not shown) for the load carrier of the hand truck, normally load forks, in a manner known per se.

The invention is thus focused on the presence of the second lever 18 that is used to lock the first lever 12 in the braking position in order to achieve a parking brake function that is described below.

In FIG. 1 the first and second levers 12, 18 are shown in their respective releasing positions influenced by not shown spring means. When the operator wish to brake the truck he will in the normal manner pull the first lever 12 towards the grip part 10 at which the spring force is overcome and the brake is activated. When the operator then releases the lever 12 the brake is released.

When the operator wish to activate the parking brake this is achieved by pulling the second lever 18 towards the breaking position shown in FIG. 2. This will also automatically bring the first lever 12 to its breaking position. The second lever 18 includes a locking part 24 in the shape of o a protrusion that in the braking position cooperates with a corresponding locking part 22 of the first lever in the shape of a cooperating recess. The friction force between the cooperating locking pats 22, 24 thereby overcomes the spring pretension and the levers 12, 18 retain the breaking position shown in FIG. 2 ever after being released by the operator and a parking brake function is achieved.

The parking brake may then be released by depressing the second lever 18 with a finger towards the position shown in FIG. 1 so that the locking is released and the levers returned to the brake release position.

An alternative release procedure also exist. The third lever 30 includes an actuation part 34 that cooperates with an actuation part 32 of the second lever 18 so that this is influenced towards its release position when the third lever 30 is pulled towards the grip part 10 (dashed position in FIG. 2). This means in the shown embodiment also that he pull rod 36 actuate the lowering valve so that it opens. I other words the lowering of a pallet automatically release the parking brake if this is active.

The first and second levers 12, 18 are preferably provided with cooperating contact surfaces 26, 28 tat are in contact with each other in the released position. This provides in addition to a good function also an aesthetically appealing shape. Furthermore the space in the upper part of the tiller arm where the levers 12, 18, 30 are fastened is preferably covered by a cover or panel that for the sake of clarity has been left out of the figures.

The invention can within the fame of the patient claims be executed in accordance with a number of alternative embodiments other than the ones described above. Thus one can for instance vary the shape and location of the levers and their cooperating parts.

1. Arrangement at the brake of a hand truck or the like including a tiller (4) with a handle (6), a first (12) pivotally journalled on a first axle (14) in he handle (6), said lever (12) being via a wire (16) or he like connected to a brake means, movement of the first lever (12) influence the brake means between a braking and a released position, the first lever (12) is by a spring means biased towards a release position, characterized in that a second lever (18) is pivotally journalled to the handle (6) on a second axle (20) essentially parallel to the first axle (14), said second lever 18 is moveable between the braking and he release positions, that the first and second levers (12, 18) includes respective mechanical locking parts (22, 24) arranged to cooperate with each other so that the locking parts (22, 24) are free from each other in the release position of the second lever (18) while the locking arts (22, 24) cooperates, when the first and second levers, (12, 18) are in the breaking position, in such a way that he spring force of the spring means is overcome and the first lever (12) is locked in its breaking position.

2. Arrangement according to claim 1, characterized in that the distance between the first axle (14) and the locking part (22) of the first lever is greater than the distance between the second axle (20) and the locking part (24) of the second lever.

3. Arrangement according to claim 1 or 2, characterized in that the locking part (24) of the second lever is constituted of a protrusion and the locking part (22) of the first lever is constituted of a recess cooperating with the protrusion (24).

4. Arrangement according to any of the claims 1 to 3, characterized in that the levers (12, 18) includes cooperating contacts surfaces (26, 28) that are in contact with each other in the released position of the levers (12, 18).

5. Arrangement according to any of the claims 1 to 4, characterized in that the wire (16) runs through an opening (29) i he second lever (18).

6. Arrangement according to any of the claims 1 to 5, characterized in that the third lever (30) is journalled in the handle (6) on a third axle (20) essentially parallel with the first and second axles (14, 20), which third lever (30) includes an actuation part (34) arranged to cooperate with an actuation part (32) of the second lever (18) so that the two locking parts (22, 24) are brought out of cooperation by the actuation of he third lever (30) and the first and second levers (12, 18) resume their respective release positions by the influence of the spring means.

7. Arrangement according to claim 6, characterized in that the second and third axle (20) coincide.

8. Arrangement according to any of the claims 6 or 7, characterized in that the third lever (30) also constitutes actuation means for the control of a lowering valve for the load carrier of the hand truck.

9. Arrangement according to claim 8, characterized in that the third lever (30) acts on the second lever (18) so that the locking parts (22, 24) are brought out of cooperation when the third lever (30) is brought to a position opening the lowering valve.
